(19) United States
(12) Patent Application Publication
(10) Pub. No.: US 2017/0100733 A1
(43) Pub. Date: Apr. 13, 2017

(54) BOTTLE KIT

(71) Applicant: BEAUTY UNION GLOBAL LIMITED, HONG KONG (CN)

(72) Inventors: YUSUF OKHAI, DUNDEE (GB); CARMIT TORDJMAN, LONDON (GB)

(73) Assignee: BEAUTY UNION GLOBAL LIMITED, HONG KONG (CN)

(21) Appl. No.: 15/314,299

(22) PCT Filed: May 26, 2015
(86) PCT No.: PCT/IB2015/053925

§ 371 Date: Nov. 28, 2016

Related U.S. Application Data
(60) Provisional application No. 62/002,944, filed on May 26, 2014.

(51) Int. Cl. B05B 11/00; B67D 7/02

(52) U.S. Cl. CPC B05B 11/0056; B67D 7/0205; B67D 7/0294; B05B 11/0035; B05B 11/30; B67D 7/42

(57) ABSTRACT

A kit comprising a refill bottle comprising a refill body, a dispensing mechanism and a refill mechanism; a master bottle provided with a liquid reservoir, and comprising a master body, a pump for dispensing the liquid from the reservoir, and a stem fluidly connected to the pump and outwardly protruding from the master body; and an engaging widget configured to allow stable docking of the refill bottle with the master bottle. The stem is positioned within the engaging widget, and the kit is configured to allow a docked refill bottle to be filled with liquid from the reservoir.

### FIELD OF THE INVENTION

The invention relates to bottles that are particularly designed in forms that are complementary to refill bottles and to kits that include such bottles.

### BACKGROUND

In recent years portable refill perfume bottles have become commercially available. The refill perfume bottles are refilled through a refill mechanism, and the liquid is dispensed from the bottle through a vaporizing mechanism. Such refill bottles are described in EPO Patent No. 1744955.

The refill bottles are typically adapted to be refilled from a regular perfume bottle that has a spraying mechanism with a stem; such stems are exposed in regular perfume bottles by removing a button mounted on the stem at the top of the spraying mechanism.

The refill bottles incorporate a refill mechanism that includes a check valve. The check valve opens when the stem of the bottle is pushed within, so that liquid is pushed inside the refill bottle through the stem. The liquid can then be dispensed through an opening of the refill bottle.

The refill bottle is adapted to be refilled with liquids such as perfumes, aftershaves, or cosmetic creams from regular bottles that are available in the industry, that thus function as reservoir bottles for the refill bottles.

When a user of the refill bottle is at home, the refill bottle may remain in a user's bag or pocket from the last outing. However, it should be filled again in order to keep enough liquid inside.

There is a need for master bottles that address the problem of refill bottles at home, when refilled or used at home. Embodiments disclosed herein address this need.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1a depicts a master bottle embodiment in a schematic side view;

FIG. 1b schematically shows a refill bottle docked in the master bottle shown in FIG. 1a;

FIG. 1c schematically shows a refill bottle and a master bottle that are flush with each other;

FIG. 2 schematically illustrates an enlarged view of a master bottle and a refill bottle, wherein the bottles have additional features aimed at facilitating use of the bottles;

FIG. 3 schematically presents a master bottle having a nipple engageable with a refill bottle;

FIG. 4 schematically presents in top view a master bottle and refill bottle embodiments interlocked with each other;

FIG. 5 schematically shows other embodiments in top view, in which both the master bottle and the refill bottle are equipped with a dispensing mechanism;

FIG. 6a schematically shows another top view, of a refill bottle, wherein the refill bottle is surrounded by the master bottle;

FIG. 6b schematically shows another top view, wherein the refill bottle is oval and is offset from the master bottle;

FIG. 6c schematically presents a kit wherein both the refill bottle and the master bottle are rectangular.

### SUMMARY OF THE INVENTION

According to one aspect, a kit is provided comprising:

a refill bottle comprising a refill body, a dispensing mechanism and a refill mechanism;

a master bottle provided with a liquid reservoir, and comprising a master body, a pump for dispensing the liquid from the reservoir, and a stem fluidly connected to the pump and outwardly protruding from said master body; and

an engaging widget configured to allow stable docking of the refill bottle with the master bottle,

wherein:

said stem is positioned within said engaging widget,

wherein the kit is configured to allow a docked refill bottle to be filled with liquid from the reservoir.

In some embodiments the docked refill bottle can be refilled when the refill bottle is urged towards the master bottle.

In some embodiments said engaging widget comprises a socket in said master bottle and said refill mechanism of said refill bottle can be accommodated within said socket.

In some embodiments said engaging widget comprises a nipple protruding from said master body, and walls in said refill bottle extend beyond said refill mechanism, and are configured to accommodate said nipple.

In some embodiments the master bottle and the refill bottle have top walls that are essentially flush with each other when the refill bottle is docked.

In some embodiments the master bottle and the refill bottle interlock.

In some embodiments said engaging widget further comprises a resilient element against which the refill bottle can be pushed.

In some embodiments the master bottle further comprises protrusions holding said resilient element in place.

In some embodiments said resilient element comprises an endcap mounted on said resilient element and configured to allow keeping the resilient element unexposed so as to provide a platform upon which the refill bottle is placed when docked onto the master bottle.

In some embodiments the endcap is affixed or firmly engaged to the resilient element and has a small hole sized and positioned to allow the stem to protrude when the endcap is pushed.

In some embodiments the endcap is engaged with walls of the master bottle, the engagement allowing travel of the endcap along the engaging widget when the endcap is pushed and released.

In some embodiments the master bottle and the refill bottle both have side walls, wherein the side walls of the refill bottle and the side walls of the master bottle are flush with each other when the refill bottle is mounted on the master bottle.

In some embodiments the refill bottle and the master bottle both have side walls, wherein the side walls of the refill bottle jut out from the side walls of the master bottle when the refill bottle is mounted on the master bottle.

In some embodiments each kit comprises a unique design identifying a liquid brand.

In some embodiments the master bottle comprises a dispensing mechanism independent of the engaging widget.

### DESCRIPTION OF THE PREFERRED EMBODIMENTS

Embodiments described herein are directed towards providing an improved reservoir bottle, a selection of which are described in the embodiments below, for illustrative purposes only.

The master bottles are characterized as having improved compatibility with refill bottles.

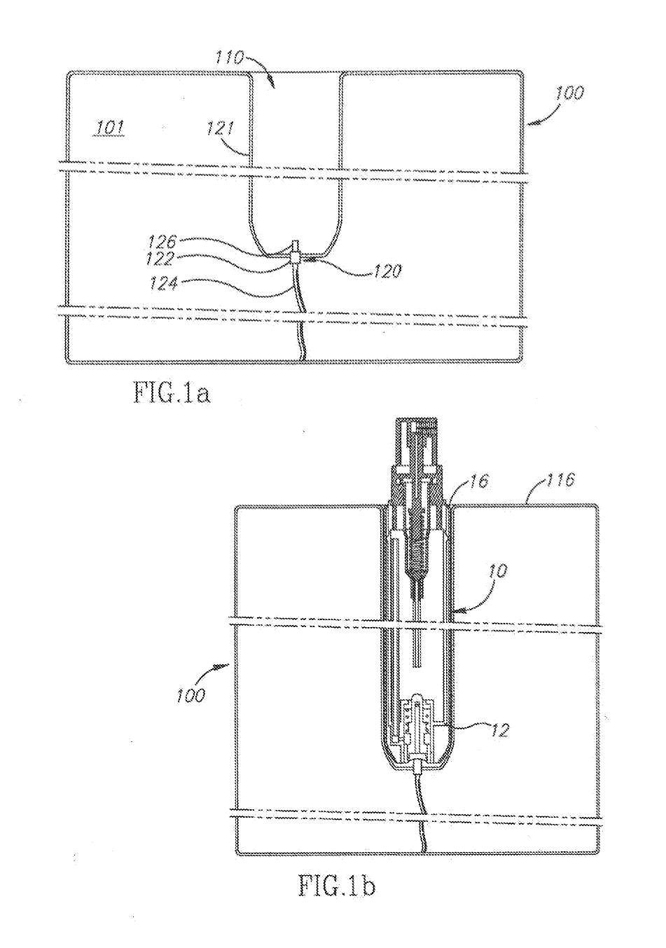

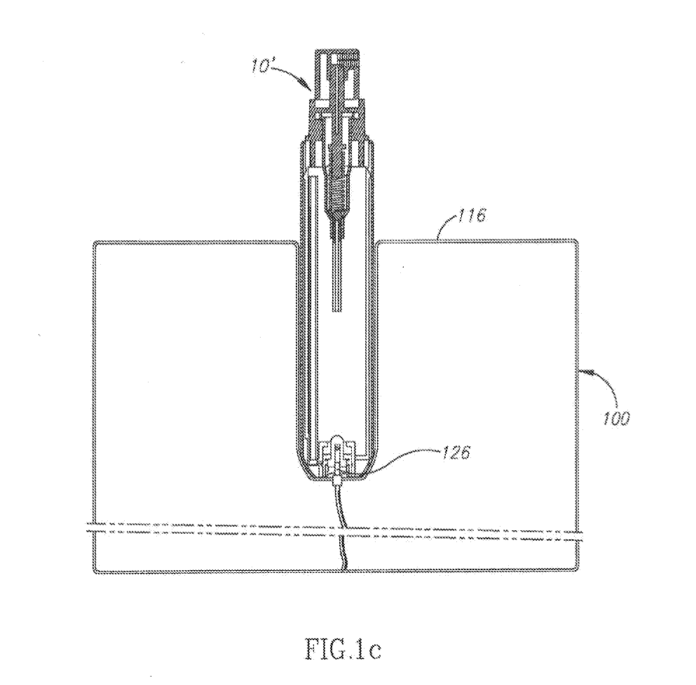

Reference is now made to FIG. 1a depicting a master bottle embodiment 100 in a schematic side cross-sectional view. The master bottle 100 is filled with liquid 101 and comprises a body 121 provided with a socket 110. The body 121 further comprises a dispensing mechanism 120, preferably at the bottom of the socket 110. The dispensing mechanism 120 includes a pump 122, a tube 124 fluidly connected thereto and extending into the liquid 101, and a rigid stem 126 fluidly connected to and outwardly extending from the pump 122; the stem 126 extends into a socket 110 in the bottle 100.

In FIG. 1b, a refill bottle 10 is docked within the socket of the master bottle 100 shown in FIG. 1a. The refill bottle 10 includes a refill mechanism 12 and a dispensing mechanism 14. As will be explained herein after, the refill mechanism 12 is configured to receive liquid 101 from the master bottle using pump 122. Urging the refill bottle 10 towards the master bottle 100 causes transfer of material from the master bottle 100 into the refill bottle 10. For example, the refill mechanism 12 includes a check valve that is opened by direct force of the stem 126, and the urging also pushes the pump 122 to dispense material. However, in other embodiments the check valve is opened by the force of the dispensed material. In yet other embodiments (not shown) the master bottle does not have a pump. For example, the master bottle is a squeeze bottle that is squeezed to allow dispensation of material. In some embodiments the refill mechanism of the refill bottle includes a check valve; in other embodiments there is no check valve; for example, the refill bottle has resilient lips that open when a stem or liquid push them open, and close when the stem is removed or the liquid is not forced. Or the refill bottle has a septum through which the stem of the master bottle can be inserted. In some, the material from the master bottle can enter the refill bottle through a narrow path that prevents spilling of liquid through capillary force.

Optionally, the master bottle 100 and the refill bottle 10 have top walls 116, 16, respectively, that are essentially flush with each other when the refill bottle 10 is mounted on the master bottle 100 (the refill bottle is placed into the socket). This matching of the master bottle 100 and the refill bottle 10 makes the master bottle 100 appear very similar to a regular perfume bottle and may reduce the risk of damage to the refill bottle 10 (both prevent it from falling and protect it from accidental blows). When the user is at home, he can use the refill bottle, when within the master bottle, in order to withdraw liquid, without having to take the refill bottle out from the socket. The top walls 16 and 116 may be flat, or they may both be curved; in the latter case, the curvatures may match to the extent that the walls 16, 116 seem to belong to a continuous surface (besides a crack separating the walls 16, 116).

Alternatively, the refill bottle 10′ may extend beyond the top wall 116 of the master bottle 100. However, preferably the refill bottle is sufficiently engaged with the master bottle (e.g. over half the height of the refill bottle is in the master bottle) to well protect the refill bottle.

The refill bottle is a bottle such as described in more details in EPO Patent No. 1744955, PCT application no. PCT/CN2009/072347, or PCT application no. PCT/IB2012/053793.

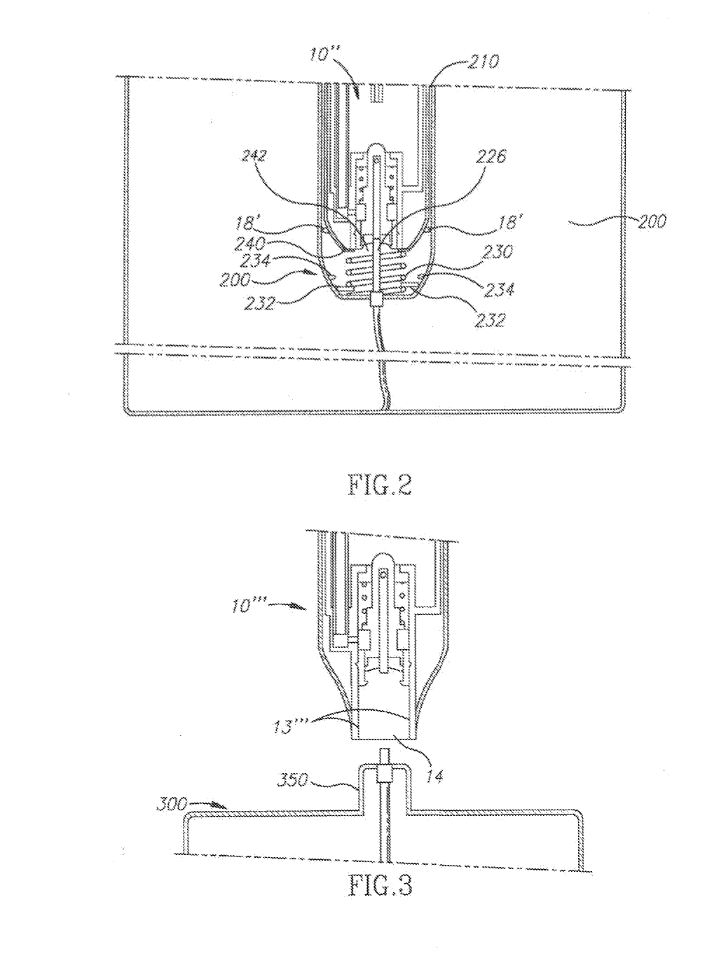

FIG. 2 shows an enlarged view of another embodiment.

The master bottle 200 further comprises a resilient element, i.e. in the figure a spring 230, provided in the bottom of socket 210. The refill bottle 10″ is being pushed repeatedly against the spring 230 and the master bottle 200 so as to be filled. The refill bottle is filled by the refill mechanism through stem 226 of the master bottle. Alternatively, protrusions 232 serve to hold the spring 230 in place inside the socket 210. An endcap 240 is mounted on the spring 230 to keep the spring unexposed and provide a convenient platform upon which the refill bottle 10″ is placed. The endcap may be affixed or firmly engaged to the spring 230, and/or may be engaged with walls of the master bottle 200 (not shown), for example the endcap 240 may have knobs that are inserted into grooves in the walls, so the knobs travel up and down the grooves when the endcap 240 is pushed. The endcap has a small hole 242 sized and positioned to allow the stem 226 to protrude when the endcap 140 is pushed. Other resilient elements can be utilized without limiting the scope of the present invention.

Alternatively, the refill bottle 10″ has two small flexible barbs 18′ which can be engaged with small teeth 234 on the master bottle 200, to help engage the refill bottle 10″ with the master bottle 200 when such engagement is desired. For example, in order to engage the refill bottle rather than refill it, the refill bottle is pushed rather harder until the barbs 18′ reach the teeth 234. Similar releasable engagement means can be utilized by the skilled in the art.

FIG. 3 schematically shows another master bottle embodiment 300 coupled to a refill bottle 10′″. The master bottle 300, unlike the two embodiments described above, does not have a socket but rather a nipple 350 upon which the refill bottle 10′″ is mounted. In both master bottles with socket or nipples, there is preferably a small gap between the refill bottle walls and the socket/nipple; in the case of master bottles with a socket, there is a small gap between the exterior side walls of the refill bottle and the side walls of the socket, and in the case of master bottles equipped with nipples 350 there is a small gap between the nipple 350 and side walls 13′″ of the refill opening 14′″ in the refill bottle. The gap is sufficiently wide to allow engaging the refill bottle with the master bottle without difficulty, yet sufficiently narrow to keep the refill bottle fairly stable in place when docked on the master bottle.

It should be noted that the engagement between the master bottle and the refill bottle can be either by a socket like member in the master bottle in which the refill bottle can rest or by the nipple like member onto which the refill bottle can be mounted. In the socket like case, the refill bottle can be a standard bottle as described in the prior art cited herein before and in the case of the nipple like member, the refill bottle is amended so as to accommodate the nipple, as shown in FIG. 3. Side walls 13′″ are an extension of the refill mechanism of the refill bottle that accord the nipple 350 of the master bottle.

FIG. 4 schematically presents another possibility of engaging the refill bottle and the master bottle; the figure shows in top view a master bottle 400 and refill bottle 10′″ embodiments interlocked with each other; Note that the bottles 10′″, 400 have side walls that are flush with each other.

Similarly, a master bottle with a nipple can interlock with a refill bottle (not shown).

Note that the interlocking structures may obviate resilient means in the socket or on the nipple. Resilient means in the refill mechanism of the refill bottle then serves for repeated pumping with the refill bottle.

The bottles may be separately sold and may be sold together as a kit. For example, a user may first purchase a kit of one refill bottle and one master bottle, in which the master bottle is provided either filled with perfume (or cologne or cream etc) or empty, as a basic kit. Other master bottles may be individually provided with different perfumes; alternatively, each perfume is associated its own set, in some embodiments, the kit is associated with the perfume by a trade dress e.g. the known labels, special shape of perfume bottle (one or both bottles may have the special shape, so for example the master bottle may have an socket shaped complementary to a refill bottle shaped in the well known form of the commercially available perfume bottles, and may also have its exterior walls in the same form).

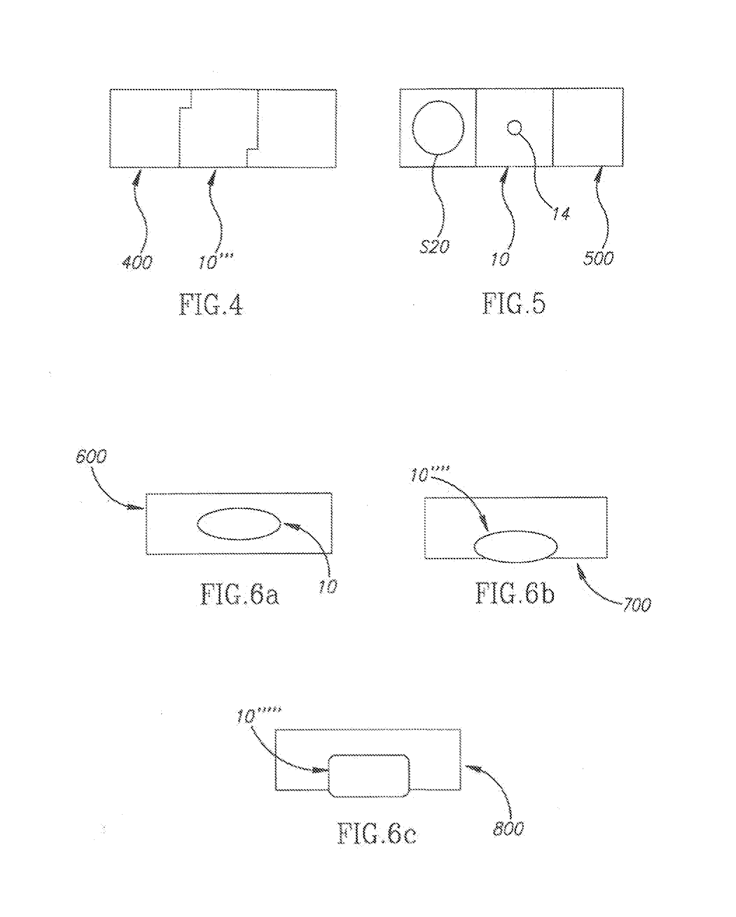

FIG. 5 schematically shows other embodiments in top view, in which both the master bottle 500 and the refill bottle 10 are equipped with a dispensing mechanism 520, 14; Such kit allows for example for two users to simultaneously share use of the perfume: one at home (having the master bottle) and one outside home (having the refill bottle).

FIG. 6a schematically shows a top view of a master bottle-refill bottle kit, wherein the refill bottle 10 is surrounded by the master bottle 600 such master bottle may appear to be a completely ordinary perfume bottle when the refill bottle is mounted thereon; the refill bottle can also be positioned off-centre on the master bottle and a dispensing mechanism may be at the centre of the master bottle (not shown), so that the master bottle not only appears (at least in a cursory side viewing) to be an ordinary perfume bottle.

FIG. 6b schematically shows another top view, wherein the refill bottle 10″″ is oval and is offset from the master bottle 700; such kits have a special design that may highlight the presence of the mounted refill bottle 10″″ and the special structure of the master bottle 700.

FIG. 6c schematically presents a kit wherein both the refill bottle and the master bottle are rectangular, similar to the structure shown in FIG. 6b.

Some refill bottles are provided with a subpressure therein that is maintained during the lifetime of the bottle. Such embodiments may be refilled from the master bottle without need to pump.

Optionally, the master bottle can comprise a dispensing mechanism that can be an atomizer or roller ball.

The refill bottle may be structured to allow filling, storage and dispensation of cream, for example see WO2013014626.

The refill bottle in some embodiments is thus of the type comprising:

a bottle having walls defining an upper cavity and a lower cavity;

a viscous composition refill mechanism configured to allow viscous composition to enter said upper cavity when said refill mechanism is fluidly coupled to a viscous composition source;

a viscous composition dispensing mechanism configured to allow viscous composition to be dispensed from said upper cavity to outside the bottle when the dispensing mechanism is actuated;

a gasket configured to substantially seal said upper cavity from said lower cavity wherein said gasket is capable of moving towards the upper cavity upon actuation of the dispensing mechanism and moving towards the lower cavity upon entrance of the viscous composition into said upper cavity.

The scope of the present invention is defined by the appended claims and includes both combinations and sub combinations of the various features described hereinabove as well as variations and modifications thereof.

In the claims, the word “comprise”, and variations thereof such as “comprises”, “comprising” and the like indicate that the components listed are included, but not generally to the exclusion of other components.

1. A kit comprising:
a refill bottle comprising a refill body, a dispensing mechanism and a refill mechanism;
a master bottle provided with a liquid reservoir, and comprising a master body, a pump for dispensing the liquid from the reservoir, and a stem fluidly connected to the pump and outwardly protruding from said master body; and
an engaging widget configured to allow stable docking of the refill bottle with the master bottle,
wherein said stem is positioned within said engaging widget, and
wherein the kit is configured to allow a docked refill bottle to be filled with liquid from the reservoir.

2. The kit of claim 1, wherein the docked refill bottle is filled when the refill bottle is urged towards the master bottle.

3. The kit of claim 1, wherein said engaging widget comprises a socket in said master bottle and said refill mechanism of said refill bottle can be accommodated within said socket.

4. The kit of claim 1, wherein:
said engaging widget comprises a nipple protruding from said master body, and
walls in said refill bottle extend beyond said refill mechanism, and are configured to accommodate said nipple.

5. The kit of claim 3, wherein the master bottle and the refill bottle have top walls that are essentially flush with each other when the refill bottle is docked.

6. The kit of claim 1, wherein the master bottle and the refill bottle interlock.

7. The kit of claim 1, wherein said engaging widget further comprises a resilient element against which the refill bottle can be pushed.

8. The kit of claim 7, wherein the master bottle further comprises protrusions holding said resilient element in place.

9. The kit of claim 7, wherein said resilient element comprises an endcap mounted on said resilient element and configured to allow keeping the resilient element unexposed so as to provide a platform upon which the refill bottle is placed when docked onto the master bottle.

10. The kit of claim 9, wherein the endcap is affixed or firmly engaged to the resilient element and has a small hole sized and positioned to allow the stem to protrude when the endcap is pushed.

11. The kit of claim 9, wherein the endcap is engaged with walls of the master bottle, the engagement allowing travel of the endcap along the engaging widget when the endcap is pushed and released.

12. The kit of claim 1, wherein the master bottle and the refill bottle both have side walls, wherein the side walls of the refill bottle and the side walls of the master bottle are flush with each other when the refill bottle is mounted on the master bottle.

13. The kit of claim 1, wherein the refill bottle and the master bottle both have side walls, and wherein the side walls of the refill bottle jut out from the side walls of the master bottle when the refill bottle is mounted on the master bottle.

14. The kit of claim 1, wherein the refill bottle and the master bottle both have side walls, and wherein the side walls of the refill bottle jut out from the side walls of the master bottle.

15. A plurality of kits according to claim 1, wherein each kit comprises a unique design identifying a liquid brand.

16. The kit of claim 1, wherein the master bottle comprises a dispensing mechanism independent of the engaging widget.
